(19) United States
(12) Patent Application Publication
(10) Pub. No.: US 2013/0220648 A1
(43) Pub. Date: Aug. 29, 2013

(54) Burn Blanket

(71) Applicant: Carson Wade Muir, Calgary (CA)

(72) Inventor: Carson Wade Muir, Calgary (CA)

(21) Appl. No.: 13/405,201

(22) Filed: Feb. 24, 2012

(51) Int. Cl. A62C 8/06

(52) U.S. Cl. 169/48

(57) ABSTRACT

The Burn Blanket is an effective way to help fire fighters protect themselves and save the lives of others. It is completely hands free and a new step in the rescue of people from fires. Made from Nomex and Kevlar and the other materials found in fire fighter equipment the burn blanket is a hands free cape that can add a new protective layer for the firefighters and be easily used to rap a victim with out having to be carried.

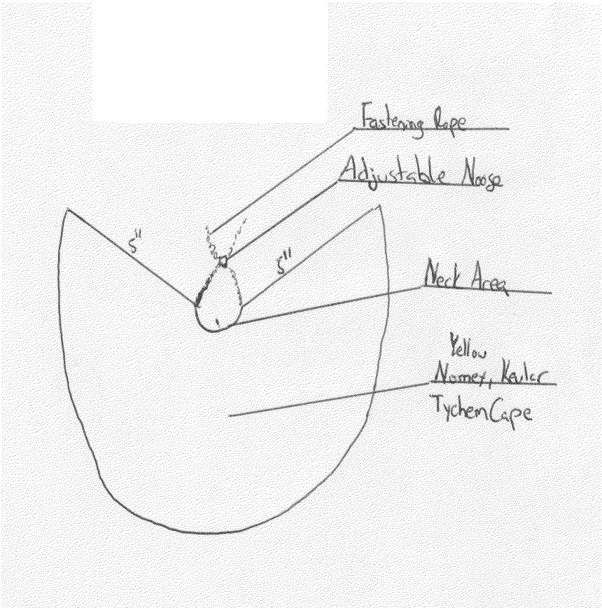

### DETAILED DESCRIPTION OF DRAWINGS

First we have the rope used to fasten the burn blanket into a cape. We also have the easily adjustable noose so a fire fighter can quickly undo the Burn Blanket and use it to cover a victim he is preparing to remove from the fire. We can also see the neck area and the size of the cape. The cape is Nomex and Kevlar like typical firefighter equipment. It may or may not have reflectors on it.

### DETAILED DESCRIPTION OF INVENTION

The Burn Blanket is made of Kevlar, Nomex, Tychem and anything else typically found in firefighters gear. It is worn as a cape when a firefighter enters a burning building. This provides a buffer from flames and heat. When the fire fighter finds a victim he removes the Burn Blanket, covers the victim with it, and removes them from the fire. This protects the victim. It also keeps the fire fighters hands free.

1) first we claim the burn blanket creates a new buffer zone to initially deflect heat and flames.

2) second we claim the burn blanket is removable, wearable and hands free creating ease of use not previously found in fire fighter apparel: The fire fighter carries the burn blanket on his back as a cape not with his hands making things easier for him.

3) Our third clam is that the Burn Blanket can be used to wrap victims making their escape safer, this is also new.
